(19) United States
(12) Patent Application Publication
(10) Pub. No.: US 2026/0264668 A1
(43) Pub. Date: Sep. 10, 2026

(54) CONTROL DEVICE, INFORMATION TERMINAL, CONTROL METHOD, AND STORAGE MEDIUM

(71) Applicant: HONDA MOTOR CO., LTD., Tokyo (JP)

(72) Inventor: Kohei MIYAMOTO, Tokyo (JP)

(73) Assignee: HONDA MOTOR CO., LTD., Tokyo (JP)

(21) Appl. No.: 19/553,441

(22) Filed: Mar. 2, 2026

(30) Foreign Application Priority Data
Mar. 5, 2025 (JP) 2025-034373

(51) Int. Cl. B60W 30/06; B60W 50/14; B60W 60/00; G01C 21/36; G08G 1/14

(52) U.S. Cl. CPC B60W 30/06; B60W 50/14; B60W 60/001; G01C 21/3614; G08G 1/144; B60W 2552/53

(57) ABSTRACT

A control device for a moving object capable of autonomous traveling to a target position includes a processor configured to acquire external environment information of the moving object, acquire attribute information on a route in a parking lot, the attribute information assigned to map information based on an instruction operation performed by a user on displayed map information of the parking lot, and control the autonomous traveling based on the external environment information and the attribute information assigned to the map information.

### CROSS-REFERENCE TO RELATED APPLICATIONS

This application is based on and claims priority under 35 USC 119 from Japanese Patent Application No. 2025-034373 filed on Mar. 5, 2025, the entire content of which is incorporated herein by reference.

### TECHNICAL FIELD

The present disclosure relates to a control device, a control method, an information terminal, and a non-transitory storage medium storing a control program.

### BACKGROUND ART

In recent years, efforts have been actively made to provide access to a sustainable transportation system in consideration of vulnerable people among traffic participants. In order to implement the above, focus has been placed on research and development on further improving safety and convenience of traffic by research and development related to prevention safety technique.

In the related art, there is known a technique in which a system causes a vehicle to autonomously travel within a parking lot and park in a predetermined parking frame without a user getting in the vehicle, and a technique of causing a vehicle to autonomously travel from a parking frame to a user who is in a predetermined position.

As an example of an automatic driving technique, CN114771510A describes a parking method based on a route map in which, in automatic parking of a vehicle, a current position of a host vehicle is acquired, and it is determined whether there is host vehicle history trajectory information including a history parking target position related to the current position.

If there is no host vehicle history trajectory information, a drawing interface is output for receiving a drawing operation by a user, and a route navigation route map including road map feature elements is generated based on the drawing operation received by the drawing interface and is displayed for confirmation by the user.

### SUMMARY OF INVENTION

However, in the related art, there is room for improvement from a viewpoint of improving convenience for a user.

Aspects of non-limiting embodiments of the present disclosure relates to providing a control device, an information terminal, a control method, and a non-transitory computer-readable storage medium storing a control program that can improve convenience of automatic traveling. This hence contributes to development of a sustainable transportation system.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided a control device for a moving object capable of autonomous traveling to a target position, the control device including a processor configured to acquire external environment information of the moving object, acquire attribute information on a route in a parking lot, the attribute information assigned to map information based on an instruction operation performed by a user on displayed map information of the parking lot, and control the autonomous traveling based on the external environment information and the attribute information assigned to the map information.

According to an aspect of the present disclosure, there is provided a control method for a control device for a moving object capable of autonomous traveling to a target position, the control method including acquiring, by a processor, external environment information of the moving object, acquiring, by the processor, attribute information on a route in a parking lot, the attribute information assigned to map information based on an instruction operation performed by a user on displayed map information of the parking lot, and performing, by the processor, a control of the autonomous traveling based on the external environment information and the attribute information assigned to the map information.

According to an aspect of the present disclosure, there is provided a non-transitory computer-readable storage medium storing a control program for a computer to perform processing, the computer configured to control a control device of a moving object capable of autonomous traveling to a target position, the processing including acquiring external environment information of the moving object, acquiring attribute information on a route in a parking lot, the attribute information assigned to map information based on an instruction operation performed by a user on displayed map information of the parking lot, and performing a control of the autonomous traveling based on the external environment information and the attribute information assigned to the map information.

According to an aspect of the present disclosure, there is provided an information terminal including a communication interface capable of communicating with a control device for a moving object capable of autonomous traveling to a target position, a user interface configured to display map information of a parking lot, and a processor, in which the processor is configured to assign attribute information on a route in the parking lot to the map information based on an instruction operation performed by a user on the map information displayed on the user interface, and cause, by transmitting the map information to which the attribute information is assigned to the control device via the communication interface, the control device to execute a control of the autonomous traveling based on external environment information of the moving object and the attribute information assigned to the map information.

The present disclosure can provide a control device, an information terminal, a control method, and a control program that can improve convenience of automatic traveling.

### BRIEF DESCRIPTION OF DRAWINGS

Exemplary embodiment(s) of the present invention will be described in detail based on the following figures, wherein:

FIG. 1 is a side view of a vehicle 1 in which a control device according to the present embodiments is installed;

FIG. 2 is a top view of the vehicle 1 illustrated in FIG. 1;

FIG. 3 is a block diagram illustrating an example of an internal configuration of the vehicle 1 illustrated in FIG. 1;

FIG. 4 is a diagram illustrating an example of a configuration of a control system that controls the vehicle 1;

FIG. 5 is a diagram illustrating an example of a hardware configuration of an information terminal 200 owned by a user U1 of the vehicle 1;

FIG. 6 is a diagram illustrating an example of map information displayed on the information terminal 200;

FIG. 7 is a diagram illustrating an example of how attribute information is assigned to map information 71;

FIG. 8 is a diagram illustrating an example of attribute information assigned to the map information 71 of a parking lot 81;

FIG. 9 is a diagram illustrating an example of a use form of the present embodiment when calling a vehicle;

FIG. 10 is a diagram illustrating a first example of a sequence for acquiring map information to which attribute information is assigned;

FIG. 11 is a diagram illustrating a second example of a sequence for acquiring map information to which attribute information is assigned;

FIG. 12 is a diagram illustrating a third example of a sequence for acquiring map information to which attribute information is assigned;

FIG. 13 is a diagram illustrating a fourth example of a sequence for acquiring map information to which attribute information is assigned;

FIG. 14 is a diagram illustrating a fifth example of a sequence for acquiring map information to which attribute information is assigned; and

FIG. 15 is a flowchart illustrating an example of processing by a control device 30 during automatic traveling of the vehicle 1.

### DESCRIPTION OF EMBODIMENTS

Hereinafter, an embodiment of a control device, an information terminal, a control method, and a non-transitory storage medium storing a control program of the present disclosure will be described with reference to the drawings. The drawings are viewed in directions of reference numerals. Note that the following embodiment does not limit the present invention, and not all of elements described in the following embodiment are necessary for the present invention. Hereinafter, the same or similar elements are denoted by the same or similar reference signs, and description thereof may be omitted or simplified.

### 1. Vehicle

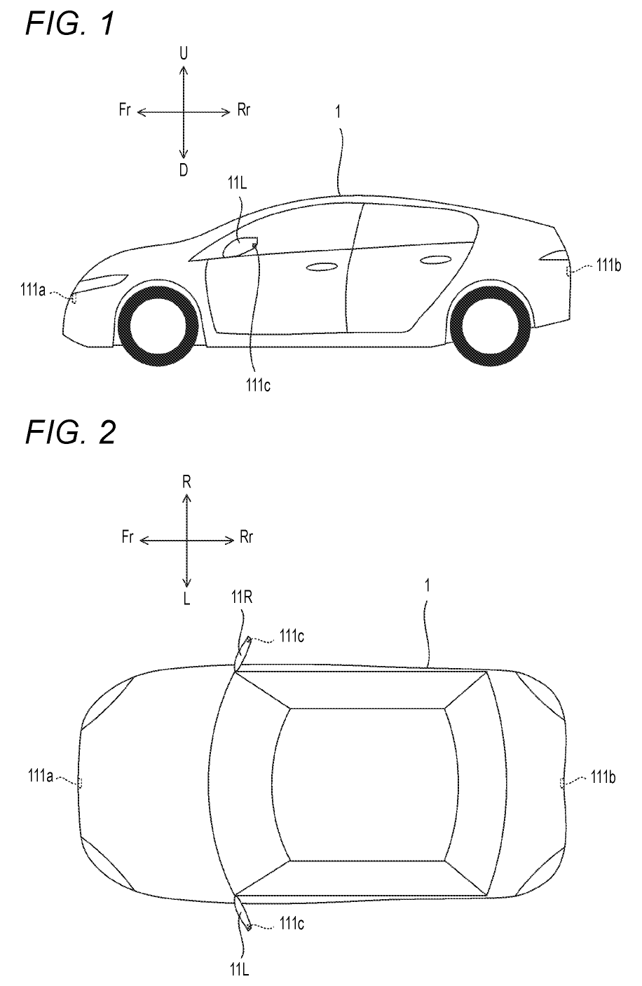

FIG. 1 is a side view of a vehicle 1 in which a control device according to the present embodiments is installed. FIG. 2 is a top view of the vehicle 1 illustrated in FIG. 1. The vehicle 1 is an example of a moving object of the present embodiment. The vehicle 1 according to the present embodiment is an automobile including a drive source (not illustrated), and wheels (not illustrated) including drive wheels driven by power of the drive source and steered wheels that are steerable. As an example, the vehicle 1 may be a four-wheeled automobile including a pair of left and right front wheels and a pair of left and right rear wheels.

The drive source of the vehicle 1 may be an electric motor, an internal combustion engine such as a gasoline engine or a diesel engine, or a combination of an electric motor and an internal combustion engine. The drive source of the vehicle 1 may drive the pair of left and right front wheels, the pair of left and right rear wheels, or the four wheels including the pair of left and right front wheels and the pair of left and right rear wheels. The front wheels and the rear wheels of the vehicle 1 may all be steerable steered wheels, or the front wheels or the rear wheels may be steerable steered wheels.

The vehicle 1 further includes side mirrors 11L and 11R. The side mirrors 11L and 11R are mirrors (back mirrors) provided on outer sides of front seat doors of the vehicle 1 for a driver to check a rear side and rear lateral sides. The side mirrors 11L and 11R are fixed to a main body of the vehicle 1 by rotation shafts extending in a vertical direction, and can be opened and closed by rotating about the rotation shafts.

The vehicle 1 further includes a front camera 111a, a rear camera 111b, and side cameras 111c. The front camera 111a is a digital camera that is provided on a front side of the vehicle 1 and images the front side of the vehicle 1. The rear camera 111b is a digital camera that is provided on a rear side of the vehicle 1 and images the rear side of the vehicle 1. The side cameras 111c are digital cameras that are respectively provided on the left and right side mirrors 11L and 11R of the vehicle 1 and images a left or right side of the vehicle 1.

### 2. Internal Configuration of Vehicle

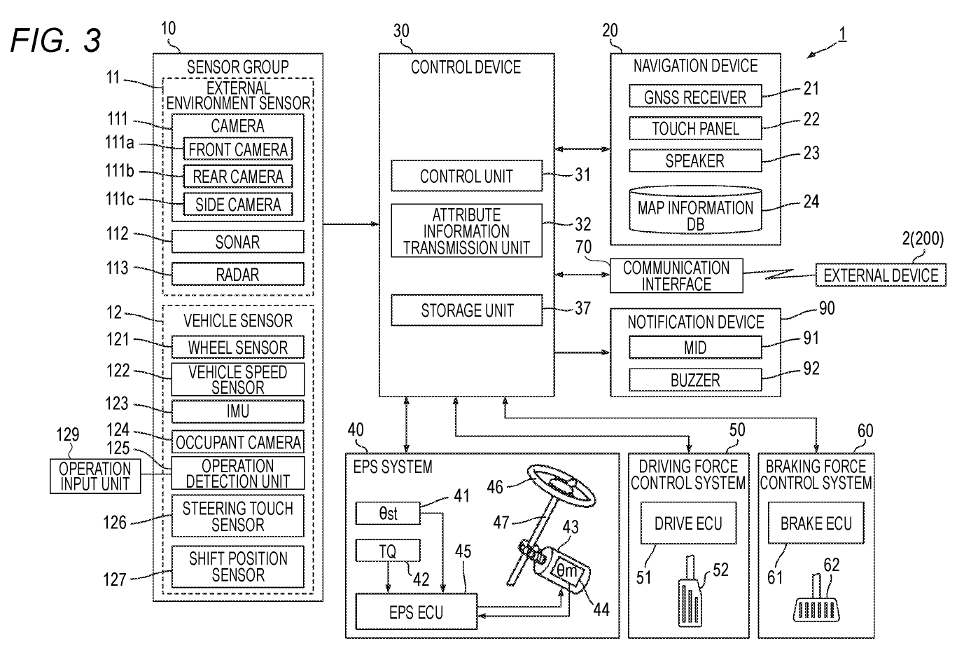

FIG. 3 is a block diagram illustrating an example of an internal configuration of the vehicle 1 illustrated in FIG. 1. The vehicle 1 includes a sensor group 10, a navigation device 20, a control device 30, an electric power steering (EPS) system 40, a driving force control system 50, a braking force control system 60, a communication interface 70, and a notification device 90.

The sensor group 10 includes an external environment sensor 11 that acquires external environment information for recognizing a periphery (in other words, surroundings) of the vehicle 1, and a vehicle sensor 12 that acquires information on the vehicle 1 (hereinafter, also referred to as "vehicle information"). The information acquired by each sensor in the sensor group 10 is output to the control device 30, and is used for control of the vehicle 1 (hereinafter, also referred to as "vehicle control") performed by the control device 30.

The external environment sensor 11 includes, for example, cameras 111, a sonar 112, and a radar 113. The cameras 111 image the periphery of the vehicle 1 including the front side of the vehicle 1, and output image data of an obtained peripheral image to the control device 30. Such image data is an example of the external environment information. The cameras 111 can be, for example, digital cameras using an imaging device such as a charge coupled device (CCD) or a complementary metal oxide semiconductor (CMOS).

More specifically, the cameras 111 include, for example, a front camera 111a, a rear camera 111b, and side cameras 111c. The front camera 111a is provided, for example, on an upper portion of a front windshield or a front grille (not illustrated) of the vehicle 1, and images a scene in front of the vehicle 1. The rear camera 111b is provided, for example, near a license plate (in other words, an automobile registration number mark) attached to a rear portion of the vehicle 1, and images a scene behind the vehicle 1. The side cameras 111c are provided, for example, on the left and right side mirrors 11L and 11R, and image scenes on lateral sides (that is, the left and right sides) of the vehicle 1. The peripheral images of the vehicle 1 captured by the front camera 111a, the rear camera 111b, the side camera 111c on the left side, and the side camera 111c on the right side are also referred to as a front image, a rear image, a left side image, and a right side image, respectively. An image constituted by the left side image and the right side image may be referred to as a lateral side image. The peripheral image of the vehicle 1 generated by combining the imaging data of the front camera 111a, the rear camera 111b, and the left and right side cameras 111c may be referred to as a top view image.

The sonar 112 emits sound waves to the periphery of the vehicle 1 (for example, the front side, the rear side, and the lateral sides of the vehicle 1), and receives reflected sounds from an object present in the periphery of the vehicle 1, thereby detecting a distance to the object from the vehicle 1, an azimuth of the object, and the like, and outputs the detection result to the control device 30. The detection result of the sonar 112 is another example of the external environment information.

The radar 113 emits radio waves to the periphery of the vehicle 1 including the front side of the vehicle 1, and receives reflected waves from an object present in the periphery of the vehicle 1, thereby detecting a distance to the object, an azimuth of the object, and the like. As the radar 113, for example, a millimeter wave radar can be adopted. The detection result of the radar 113 is another example of the external environment information.

Note that the external environment sensor 11 may include light detection and ranging (LiDAR) instead of or in addition to the sonar 112 and the radar 113. In this case, the LiDAR emits laser light to the periphery of the vehicle 1 including the front side of the vehicle 1, and receives reflected light from an object present in the periphery of the vehicle 1, thereby detecting a distance to the object from the vehicle 1, an azimuth of the object, and the like.

The vehicle sensor 12 includes, for example, a wheel sensor 121, a vehicle speed sensor 122, an inertial measurement unit (IMU) 123, an occupant camera 124, an operation detection unit 125, a steering touch sensor 126, and a shift position sensor 127.

The wheel sensor 121 detects a rotation angle of one or more wheels among the wheels of the vehicle 1. As an example, the wheel sensor 121 detects rotation angles of the left rear wheel and the right rear wheel. As the wheel sensor 121, for example, an angle sensor or a displacement sensor can be adopted.

The vehicle speed sensor 122 detects a vehicle speed VP that is a travel speed of the vehicle 1 (in other words, a movement speed of a vehicle body). For example, the vehicle speed sensor 122 detects the vehicle speed VP based on a rotation speed of a countershaft (not illustrated) provided in the vehicle 1.

The inertial measurement unit 123 detects angular velocities of the vehicle 1 in a pitch direction, a roll direction, and a yaw direction, and accelerations of the vehicle 1 in a front-rear direction, a left-right direction, and an upper-lower direction. Note that the vehicle sensor 12 may include, instead of the inertial measurement unit 123, an acceleration sensor that detects an acceleration of the vehicle 1 in a predetermined direction and a gyro sensor that detects an angular velocity of the vehicle 1 in a predetermined direction.

The occupant camera 124 is a digital camera that images an interior of the vehicle 1 and outputs image data of an obtained interior image to the control device 30. For example, the occupant camera 124 can be a so-called "driver monitor camera" that can capture an image of a head of an occupant seated in a driver seat of the vehicle 1 (for example, a user driving the vehicle 1, hereinafter simply referred to as "user") from the front. As the occupant camera 124, a digital camera using an imaging element such as the CCD or the CMOS can be adopted, similarly to the camera 111.

The operation detection unit 125 detects an operation performed by using an operation input unit 129 that is operable by the user. The operation input unit 129 may include, for example, a switch or a button that receives a command related to parking assistance to be described later.

The steering touch sensor 126 detects whether a steering 46 of the vehicle 1 is gripped appropriately. For example, the steering touch sensor 126 is implemented by a capacitance sensor or the like. In this case, the capacitance sensor is provided at a portion touched by the user when the steering 46 is gripped appropriately.

The shift position sensor 127 detects, for example, whether a shift position of a shift lever (not illustrated) provided in the vehicle 1 is any one of "P (parking)", "R (reverse)", "N (neutral)", and "D (drive)". When the vehicle 1 may take another shift position (for example, "B (brake)") other than the "P", the "R", the "N", and the "D", the shift position sensor 127 may also detect whether the shift position is the other shift position.

The navigation device 20 includes, for example, a global navigation satellite system (GNSS) receiver 21, a touch panel 22, and a speaker 23. The navigation device 20 includes a storage unit (not illustrated) implemented by a flash memory or the like. The storage unit of the navigation device 20 stores a map information database (DB) 24 and the like. The touch panel 22 is an example of the "display" in the present embodiment.

The map information database 24 includes road network information. The road network information is information representing roads based on a combination of nodes and links connecting the nodes (also referred to as "paths"). Each of the nodes in the road network information represents, for example, a feature of a corresponding road such as an intersection, a corner, or a dead end. In the road network information, for each of the nodes, for example, information indicating a location corresponding to the node (for example, coordinates that enable specifying of one point on a map such as a latitude and a longitude) is set. Further, in the road network information, for each of the links, information indicating nodes at both ends of the link, a road corresponding to the link, a link length, a lane number, a traveling direction, a road type, and the like is set.

The GNSS receiver 21 specifies a current position of the vehicle 1 (for example, a latitude and a longitude of a location where the vehicle 1 is positioned) based on a signal received from a GNSS satellite. Note that, the navigation device 20 may acquire a detection result of the vehicle sensor 12 (for example, the wheel sensor 121 or the vehicle speed sensor 122) via the control device 30, and specify or complement the current position of the vehicle 1 by an inertial navigation system (INS) using a detection value of the vehicle sensor 12.

For example, the touch panel 22 is implemented by combining a display device such as a liquid crystal display or an organic light emitting diode (OLED) with a pointing device (for example, a touch pad). The speaker 23 is configured to output a sound to the occupant of the vehicle 1 including the user. The touch panel 22 is an example of a notification unit capable of issuing a notification to the user. The speaker 23 is another example of the notification unit capable of issuing a notification to the user.

For example, the navigation device 20 searches for, by referring to the map information database 24, a route from the current position of the vehicle 1 to a destination set by the user using the touch panel 22. Then, the navigation device 20 performs route guidance using the touch panel 22 and the speaker 23 based on the found route.

Further, the navigation device 20 may cause the touch panel 22 to perform a predetermined display according to an instruction from the control device 30. Further, the navigation device 20 may output predetermined information (for example, information indicating an operation received via the touch panel 22) to the control device 30.

For example, the navigation device 20 may cause, according to the instruction from the control device 30, the touch panel 22 to display an operation button for receiving a command request related to parking assistance. Further, the navigation device 20 may output, to the control device 30, operation information of the command request related to the parking assistance received via the touch panel 22. "Parking assistance" refers to assistance for causing the vehicle 1 to perform automatic parking at a predetermined parking position, or causing the vehicle 1 to perform automatic exiting from a parking position to a predetermined calling position (for example, where the user is). The predetermined parking position and the predetermined calling position are examples of a target position of the present embodiment.

Specifically, the navigation device 20 causes the touch panel 22 to display a parking assistance button for requesting the parking assistance of the vehicle 1, and an exiting assistance button for requesting exiting assistance. The parking assistance button includes an automatic parking button for requesting parking by the automatic steering by the control device 30, and a parking support button for requesting support during parking of the vehicle 1 by an operation of the user. The exiting assistance button includes an automatic exiting button for requesting exiting by the automatic steering by the control device 30, and an exiting support button for requesting support while exiting by an operation of the user. When the parking assistance button or the exiting assistance button is operated via the touch panel 22, the navigation device 20 outputs operation information to the control device 30.

Note that as a device for inputting or a device for displaying a command request related to the parking assistance, components other than the touch panel 22, such as an information terminal such as a head-up display (HUD), a smartphone, or a tablet, may be used as the input device or the display device.

For example, the "parking" is a stop as the occupant gets on or off the vehicle, and excludes a temporary stop due to a traffic signal or the like. Further, the "parking position" means a position where the vehicle 1 is to be stopped, that is, a position to be parked to.

The control device 30 is an example of the control device according to the present embodiment and is a computer that integrally controls the entire vehicle 1. The control device 30 includes, for example, a processor (not illustrated) that performs various calculations, a storage unit 37 including a non-transitory storage medium that stores various types of information (for example, programs and various types of data), and an input and output unit (not illustrated) as an interface that controls input and output of data between inside and outside of the control device 30. The storage unit 37 stores various types of data, such as information on the automatic traveling (automatic parking/automatic exiting) of the vehicle 1. The automatic traveling is an example of autonomous traveling in the present embodiment.

The control device 30 also includes a control unit 31 and an attribute information transmission unit 32 as functional units implemented by the processor executing the programs stored in the storage unit 37. These functional units will be described later, and thus the description thereof will be omitted here. Note that the control device 30 can be implemented by one electronic control unit (ECU) or by a plurality of ECUs working together.

The EPS system 40 includes, for example, a steering angle sensor 41, a torque sensor 42, an EPS motor 43, a resolver 44, and an EPS ECU 45.

The steering angle sensor 41 detects a steering angle θst of the steering 46 and outputs information indicating the detected steering angle θst to the EPS ECU 45. The torque sensor 42 detects a steering torque TQ, which is a torque applied to the steering 46 of the vehicle 1, and outputs information indicating the detected steering torque TQ to the EPS ECU 45.

The EPS motor 43 assists the user in operating the steering 46 by applying, according to an instruction from the EPS ECU 45, a driving force, or a reaction force to a steering column 47 coupled to the steering 46. The resolver 44 detects a rotation angle θm of the EPS motor 43 and outputs information indicating the detected rotation angle θm to the EPS ECU 45.

The EPS ECU 45 is a computer which includes, for example, a processor that performs various calculations, a storage unit including a non-transitory storage medium that stores various types of information, and an input and output unit that controls input and output of data between the inside and the outside of the EPS ECU 45 (none is shown), and controls the EPS system 40 (for example, the EPS motor 43). The EPS ECU 45 is implemented by one or two or more ECUs. For example, the EPS ECU 45 controls the EPS system 40 (for example, the EPS motor 43) based on the steering angle θst detected by the steering angle sensor 41, the steering torque TQ detected by the torque sensor 42, the rotation angle θm detected by the resolver 44, and the like. The EPS ECU 45 can also control the EPS system 40 according to an instruction from the control device 30.

The EPS system 40 (for example, the EPS ECU 45) may output, to the control device 30, information indicating the steering angle θst detected by the steering angle sensor 41, the steering torque TQ detected by the torque sensor 42, the rotation angle θm detected by the resolver 44, and the like. Further, the EPS system 40 (for example, the EPS ECU 45) may output information indicating a steering speed ω of the steering 46 to the control device 30. In this case, the steering speed ω is obtained by, for example, differentiating the steering angle θst with respect to time.

The driving force control system 50 includes a drive ECU 51, and is configured to control a driving force of the vehicle 1. The drive ECU 51 is a computer that includes, for example, a processor that performs various calculations, a storage unit including a non-transitory storage medium that stores various types of information, and an input and output unit that controls input and output of data between the inside and the outside of the drive ECU 51 (none is shown), and controls the driving force control system 50. The drive ECU 51 is implemented by one or more ECUs. For example, the drive ECU 51 controls power output from the drive source of the vehicle 1, based on an operation on an accelerator pedal 52 provided in the vehicle 1. The drive ECU 51 can also control the driving force control system 50 (for example, the drive source) according to an instruction from the control device 30.

The braking force control system 60 includes a brake ECU 61, and is configured to control a braking force of the vehicle 1. The brake ECU 61 is a computer that includes, for example, a processor that performs various calculations, a storage unit including a non-transitory storage medium that stores various types of information, and an input and output unit that controls input and output of data between the inside and the outside of the brake ECU 61 (none is shown), and controls the braking force control system 60. The brake ECU 61 is implemented by one or more ECUs. For example, the brake ECU 61 controls the braking force of the vehicle 1 by controlling a brake device (not illustrated) provided in the vehicle 1, based on an operation on a brake pedal 62 provided in the vehicle 1. Here, the brake device includes, for example, a brake caliper, a cylinder that transmits a hydraulic pressure to the brake caliper, and an electric motor that generates a hydraulic pressure in the cylinder. The brake ECU 61 controls an electric motor of the brake device such that a braking force corresponding to the operation on the brake pedal 62 is generated. The brake ECU 61 can also control the braking force control system 60 (for example, the brake device) according to an instruction from the control device 30.

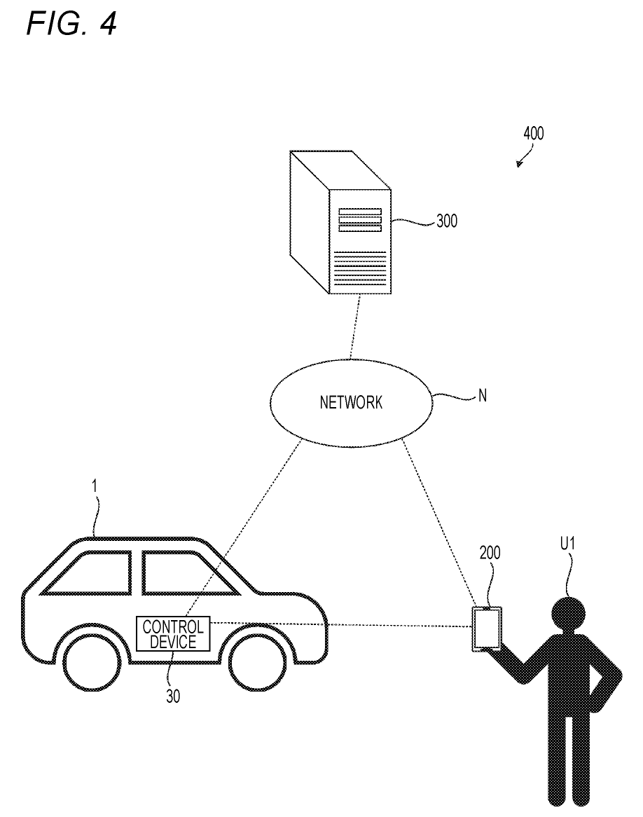

The communication interface 70 is a communication interface that communicates with an external device 2 under control by the control device 30. That is, the control device 30 may communicate with the external device 2 via the communication interface 70. Examples of the external device 2 include an information terminal 200 (see FIG. 4) of the user and a server device managed by a manufacturer of the vehicle 1. For example, a mobile communication network such as a cellular line, WI-FI (registered trademark), or Bluetooth (registered trademark) can be used for the communication between the vehicle 1 and the external device 2.

The notification device 90 is a device that issues a notification (for example, an alarm) to the user under the control of the control device 30. The notification device 90 includes, for example, a multi-information display (MID) 91 and a buzzer 92.

The MID 91 is implemented by a display device such as a liquid crystal display or an OLED, and is provided at a position that can be visually recognized by the user (for example, in a meter panel of the vehicle 1). For example, the MID 91 displays a predetermined image according to an instruction from the control device 30. The MID 91 is another example of the notification unit capable of issuing a notification to the user. The MID 91 may be integrated with the touch panel 22 described above.

The buzzer 92 is configured to output a predetermined sound. For example, the buzzer 92 outputs a predetermined alarm sound or a sound effect according to an instruction from the control device 30. The buzzer 92 is another example of the notification unit capable of issuing a notification to the user. The buzzer 92 may be integrated with the speaker 23 described above.

Next, each functional unit of the control device 30 will be described in detail. For example, the control unit 31 acquires external environment information on a surrounding situation of the vehicle 1 from the external environment sensor 11. The control unit 31 acquires attribute information on, for example, a route in a parking lot, that is assigned to map information. The "attribute information" refers to, for example, one-way street, two-way street, temporary stopping area, and no stopping area. The attribute information may also include, for example, an intersection, a speed bump, and the like. The attribute information includes information on traveling restrictions in the parking lot. The attribute information is assigned to the map information based on an instruction operation from the user to the displayed map information of the parking lot. The "map information of the parking lot" refers to area information that indicates an area of the parking lot, and does not include information on traveling routes in the parking lot. The "instruction operation" refers to, for example, a touch operation by the user on the touch panel 22 of the navigation device 20 or a display screen of the information terminal 200 (such as a smartphone).

The control unit 31 performs control to cause the vehicle 1 to perform automatic traveling to a target position, for example, based on the external environment information and the attribute information assigned to the map information. The "automatic traveling to a target position" may refer to, for example, automatic traveling from a parking position to a getting-in position (calling position) of the user (automatic exiting), or automatic traveling from a getting-out position of the user to a predetermined parking position (automatic parking). The automatic traveling to the target position may refer to memory parking with the user inside the vehicle. The memory parking refers to automatic traveling based on information on a traveling route to a target position that has been stored in advance and the like. The automatic traveling to a target position refers to traveling in a "parking lot" for example.

The control unit 31 causes the touch panel 22 to display the map information of the parking lot and receives the instruction operation from the user on the displayed map information via the touch panel 22. The control unit 31 assigns the attribute information to the map information of the parking lot in response to the instruction operation from the user received via the touch panel 22.

The map information of the parking lot can also be displayed on the information terminal 200 of the user. The information terminal 200 receives the instruction operation from the user on the displayed map information and assigns the attribute information to the map information of the parking lot. The control unit 31 acquires the attribute information of the parking lot that has been assigned to the map information in the information terminal 200 from the information terminal 200 via the communication interface 70 that can communicate with the information terminal 200. A method for assigning the attribute information to the map information of the parking lot may be such that both an instruction operation on the touch panel 22 and an instruction operation on the information terminal 200 are possible.

The map information indicates an area corresponding to the parking lot. The attribute information is assigned to the map information in association with position coordinates in the parking lot. The control unit 31 controls the automatic traveling of the vehicle 1 based on a route in the parking lot recognized based on the external environment information and the attribute information associated with the position coordinates of the route in the parking lot.

Specifically, the control unit 31 recognizes a visible route and position coordinates thereof in the parking lot based on the external environment information acquired by the external environment sensor 11. The control unit 31 recognizes the attribute information of the recognized route (one-way street, two-way street, temporary stopping area, no stopping area, intersection, speed bump, and the like) using the position information of the attribute information assigned to the map information. The control unit 31 causes the vehicle 1 to perform automatic traveling according to the recognized route and the attribute information thereof. In this way, even a position that currently cannot be seen due to an obstacle or the like and is difficult to be recognized as an intersection where another road branches off can be clearly recognized as an intersection. Therefore, it is possible to decelerate appropriately before an intersection, for example. Even a position that is difficult to be recognized as a speed bump due to a road surface condition and the like can be clearly recognized as a speed bump, thereby allowing appropriate deceleration in advance. When recognizing the route in the parking lot based on the external environment information, the control unit 31 may improve accuracy of recognizing the route in the parking lot based on a position of an intersection or a speed bump assigned to the map information.

The control unit 31 preferentially sets, as a movement route for the automatic traveling, a route candidate to which the attribute information is assigned in the map information, from among a plurality of route candidates for the automatic traveling of the vehicle 1. The word "preferentially" means that the route candidate is given priority over those to which the attribute information is not assigned.

The control unit 31 may set only the route to which the attribute information is assigned in the map information as the movement route for the automatic traveling of the vehicle 1. The control unit 31 may set a route to which no attribute information is assigned as a traveling prohibited route for the vehicle 1.

The control unit 31 detects, based on the external environment information, first attribute information on a route at a first location in the parking lot, which is not associated with the first location in the map information, and when the first location is not associated with second attribute information that is different from the first attribute information in the map information, the control unit 31 assigns the first attribute information to the map information of the parking lot in association with the first location. For example, if a one-way street sign is detected based on camera information, and "one-way street" is not associated with that location in the map information, and no other attribute information is associated with that location in the map information, the "one-way street" sign detected based on the camera information is associated with that location in the map information.

The control unit 31 detects, based on the external environment information, first attribute information that is not associated with the first location in the map information, and if second attribute information is associated with the first location in the map information, the control unit 31 performs conflict determination on the first attribute information and the second attribute information, and if the first attribute information and the second attribute information do not conflict with each other, associates the first attribute information detected based on the external environment information with the first location and adds and assigns the first attribute information to the map information. The "conflict determination" is a determination as to whether two attributes are in conflict with each other (or are compatible with each other). The conflict relationship is defined in advance for each type of attribute information. For example, the one-way street and the two-way street are conflicting types of attribute information. The temporary stopping area and the intersection are compatible (non-conflicting) types of attribute information. Therefore, the control unit 31 detects, based on the external environment information, attribute information of an intersection that is not associated with the first location in the map information, and if attribute information of a temporary stopping area is associated with the first location in the map information, the control unit 31 performs conflict determination on the attribute information of an intersection and the attribute information of a temporary stopping area, and since the attribute information of an intersection and the attribute information of a temporary stopping area do not conflict with each other, associates the attribute information of an intersection detected based on the external environment information with the first location and adds and assigns the attribute information of an intersection to the map information.

The control unit 31 detects, based on the external environment information, first attribute information that is not associated with the first location in the map information, and when second attribute information is associated with the first location in the map information, the control unit 31 performs conflict determination between the first attribute information and the second attribute information, and when the first attribute information and the second attribute information conflict with each other, performs inquires to the user about whether to update the second attribute information to the first attribute information. When receiving an update operation from the user in response to the inquiry, the control unit 31 substitutes the second attribute information with the first attribute information detected based on the external environment information and assigns the first attribute information to the map information in association with the first location. For example, the control unit 31 detects attribute information of a one-way street that is not associated with the first location in the map information based on the external environment information, and if attribute information of a two-way street is associated with that first location, the control unit 31 inquires of the user, and if receiving an update operation from the user, the control unit 31 overwrites the map information from the attribute information of a two-way street to the attribute information of a one-way street and assigns the attribute information of a one-way street to the map information in association with the first location.

The attribute information transmission unit 32 transmits the map information to which the attribute information has been assigned to the server 300 (see FIG. 4) via the communication interface 70. The user can assign transmission permission information indicating whether the attribute information can be transmitted to the server 300 by a user operation. For example, attribute information on a parking lot of a commercial facility is a public attribute that is highly useful to many users. Attribute information on a parking lot in a company may be a private attribute including attribute information that should not be made known to outsiders. The user can assign "transmission permission information" that denies transmission to the server 300, for example, for private attributes and the like. The attribute information transmission unit 32 transmits the map information to which the attribute information has been assigned to the server 300 based on the transmission permission information. Note that when setting attribute information using the information terminal 200, the information may be transmitted directly from the information terminal 200 to the server 300, or the vehicle 1 may transmit the information received from the information terminal 200 to the server 300.

### 3. Control System

FIG. 4 is a diagram illustrating an example of a configuration of a control system that controls the vehicle 1. As illustrated in FIG. 4, a control system 400 includes the control device 30 installed in the vehicle 1, the information terminal 200 carried by a user U1, and the server 300. The control device 30 and the information terminal 200 are connected to the server 300 via a network N so as to be able to communicate with each other. The control device 30 and the information terminal 200 may communicate with each other via the network N, via the network N and the server 300, or directly via Bluetooth or the like. Communication via the network N and the server 300 means, for example, the information terminal 200 transmitting the map information to which the attribute information has been assigned to the server 300 via the network N, and the server 300 transmitting the map information to the control device 30 via the network N.

The server 300 is an external server installed in a facility such as a management center. The server 300 manages the map information to which the attribute information has been assigned and which is transmitted from the control device 30 and the information terminal 200. For example, map information to which a public attribute has been assigned is transmitted from the server 300 to the control device 30 and the information terminal 200. Map information to which a private attribute including use restriction information has been assigned may also be transmitted from the control device 30 and the information terminal 200 to the server 300. The use restriction information is information indicating that only use by specific users are allowed. The server 300 may transmit the map information to which a private attribute including the use restriction information has been assigned only to a user who has identification information indicating that the user is the specific user.

### 4. Hardware Configuration of Information Terminal

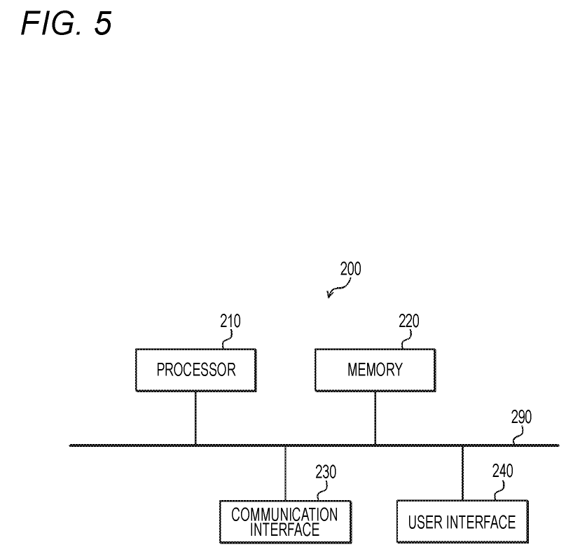

FIG. 5 is a diagram illustrating an example of a hardware configuration of the information terminal 200 owned by the user U1 of the vehicle 1. The information terminal 200 includes a processor 210, a memory 220, a communication interface 230, and a user interface 240. The processor 210, the memory 220, the communication interface 230, and the user interface 240 are connected via, for example, a bus 290.

The processor 210 is a circuit that executes signal processing, and is, for example, a central processing unit (CPU) that controls the entire information terminal 200. Note that the processor 210 may be implemented by another digital circuit such as a field programmable gate array (FPGA) or a digital signal processor (DSP). The processor 210 may also be implemented by combining a plurality of digital circuits.

The memory 220 includes, for example, a main memory and an auxiliary memory. The main memory is, for example, a random access memory (RAM). The main memory is used as a work area of the processor 210.

The auxiliary memory is a non-volatile memory such as a magnetic disk, an optical disk, or a flash memory. The auxiliary memory stores various programs for operating the information terminal 200. The programs stored in the auxiliary memory are loaded into the main memory and executed by the processor 210.

The auxiliary memory may include a portable memory removable from the information terminal 200. Examples of the portable memory include a universal serial bus (USB) flash drive, a memory card such as a secure digital (SD) memory card, and an external hard disk drive.

The communication interface 230 is an example of a "communication interface " in the present embodiment, and is capable of wireless communication with the outside of the information terminal 200 (for example, the communication interface 70 of the vehicle 1). For example, the communication interface 230 includes a UWB interface for performing UWB communication with the vehicle 1. The communication interface 230 is controlled by the processor 210.

The user interface 240 includes, for example, an input device that receives an operation input from the user U1 and an output device that outputs information to the user U1. The input device may be implemented by, for example, a touch panel. The user interface 240 is an example of a "display" in the present embodiment, and displays the map information of the parking lot. The user interface 240 receives an instruction operation from the user on the displayed map information. The output device can be implemented by, for example, a display or a speaker. The user interface 240 is controlled by the processor 210.

For example, the processor 210 assigns the attribute information on the route in the parking lot to the map information based on an instruction operation from the user on the map information of the parking lot displayed on the user interface 240. The processor 210 transmits the map information to which the attribute information has been assigned to the control device 30 of the vehicle 1 via the communication interface 230, thereby causing the control device 30 to control the automatic traveling based on the external environment information of the vehicle 1 and the attribute information assigned to the map information.

### 5. Assignment of Attribute Information

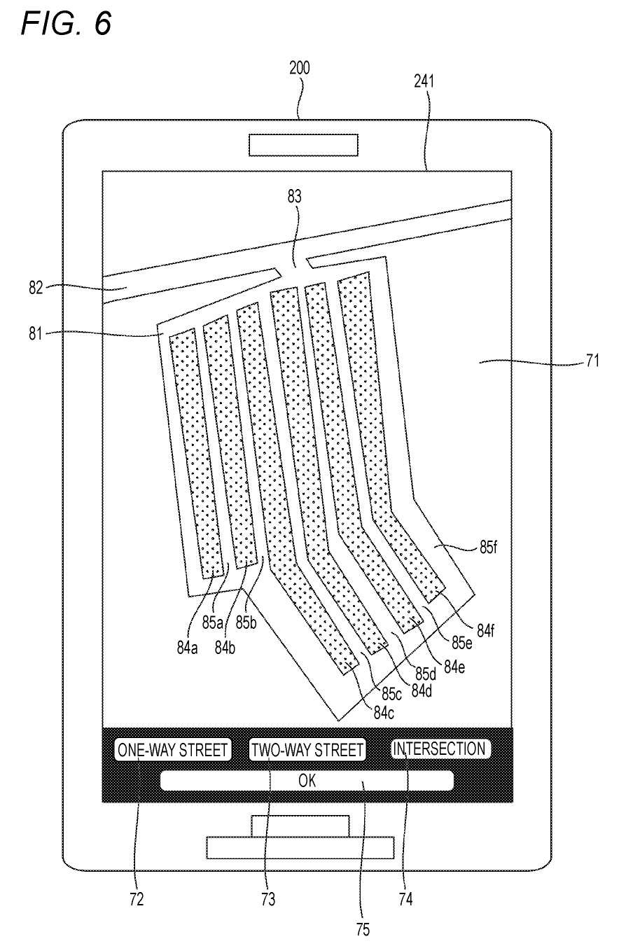

FIG. 6 is a diagram illustrating an example of the map information displayed on the information terminal 200. As illustrated in FIG. 6, the touch panel 241 of the information terminal 200 displays map information 71 of a parking lot 81 registered by, for example, a map maker and stored in the map information database 24 of the vehicle 1. The touch panel 241 is an example of a "display" in the present embodiment. The map information 71 of the parking lot 81 is area information that indicates an area corresponding to the parking lot 81. The parking lot 81 is connected to a road 82 via an entrance or exit road 83. Within the area of the parking lot 81, there are parking areas 84a to 84f where vehicles can be parked, traveling routes 85a to 85e formed between the parking areas 84a to 84f, and a traveling route 85f formed around the parking areas 84a to 84f.

The touch panel 241 also displays a "one-way street" button 72, a "two-way street" button 73, and an "intersection" button 74 for selecting the attribute information to be assigned to the map information 71. The types of the attribute information to be assigned to the map information 71 are not limited to the above, and it is possible to display other types of attribute information by, for example, a swipe operation. On the touch panel 241, an "OK" button 75 that is tapped when the assignment of the attribute information to the map information 71 is completed is also displayed. Note that in the present example, a case has been described in which map information of the parking lot is displayed on the information terminal 200, but the present invention is not limited thereto. The map information of the parking lot may be displayed on the navigation device 20 of the vehicle 1.

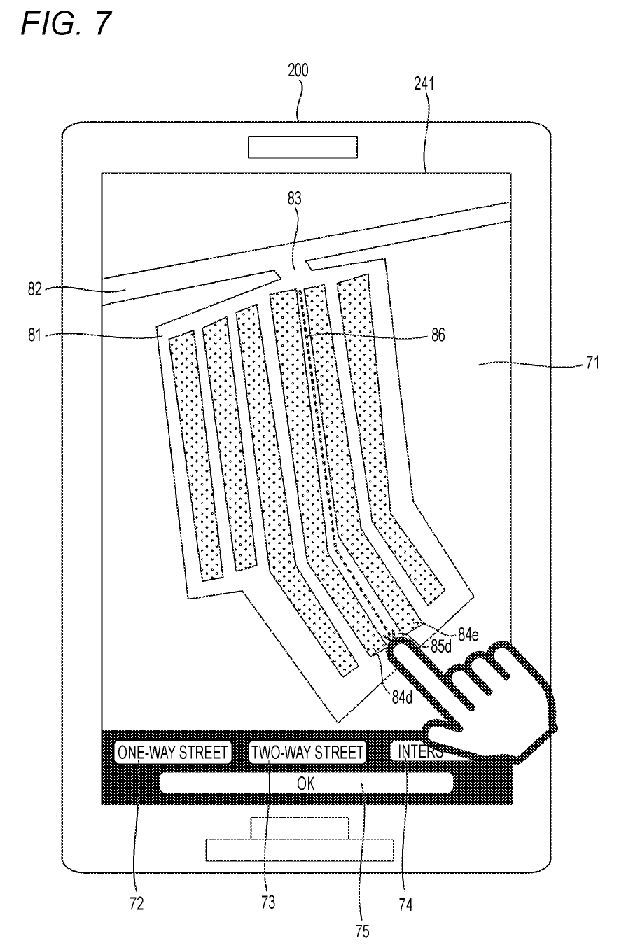

FIG. 7 is a diagram illustrating an example of how the attribute information is assigned to the map information 71. In the example illustrated in FIG. 7, an instruction operation from the user for assigning attribute information of "one-way street" to a traveling route within the area of the parking lot 81 will be described.

First, the user taps the "one-way street" button 72. Next, the user designates, for example, with a finger, a start location of a traveling route to which the user wants to assign attribute information of "one-way street", moves the finger to an end location of the one-way street route, and then releases the finger. For example, as illustrated in FIG. 7, when assigning attribute information of "one-way street" to the traveling route 85d formed between the parking area 84d and the parking area 84e, the user presses his or her finger on the position of the traveling route 85d on the road 82 side, which is the start location, and moves the finger along the traveling route 85d to the end location. By this instruction operation, a "one-way street" attribute 86 as indicated by a dashed arrow is assigned to the traveling route 85d.

The processor 210 of the information terminal 200 recognizes position coordinates of the "one-way street" attribute 86 within the area of the parking lot 81 based on GPS. The processor 210 stores the recognized "one-way street" attribute 86 and the position coordinates thereof in the memory 220 and transmits to the control device 30 of the vehicle 1. The control device 30 of the vehicle 1 stores the received "one-way street" attribute 86 and the position coordinates thereof in the storage unit 37.

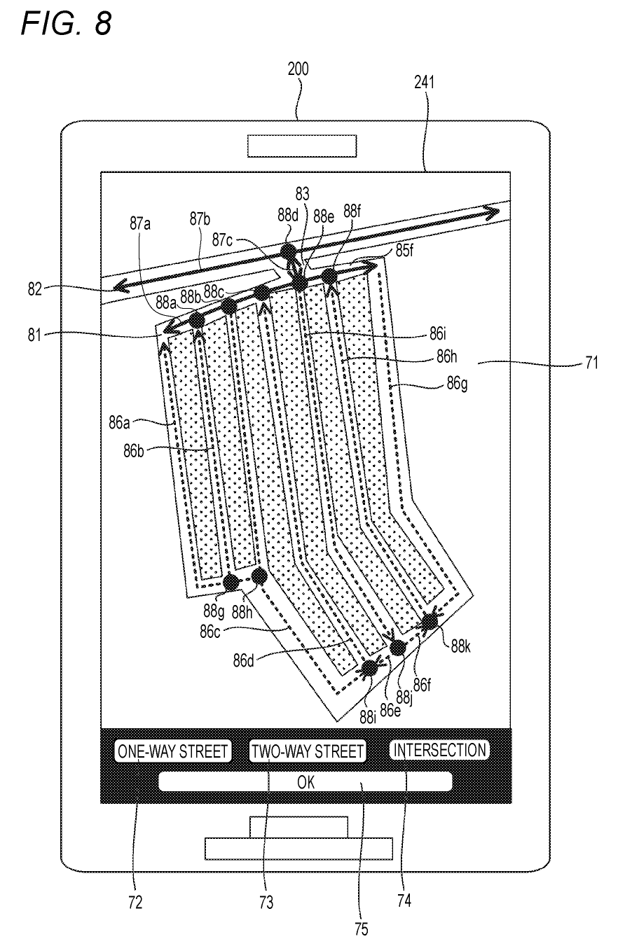

FIG. 8 is a diagram illustrating an example of attribute information assigned to the map information 71 of the parking lot 81. As illustrated in FIG. 8, the "one-way street" attributes 86a to 86i as indicated by dashed arrows are assigned to the traveling routes 85a to 85f (see FIG. 6) formed between and around the parking areas 84a to 84f within the area of the parking lot 81. Of the traveling route 85f formed around the parking areas 84a to 84f within the area of the parking lot 81, a "two-way street" attribute 87a as indicated by a solid arrow is assigned to a part of the traveling route 85f that is close to the road 82. A "two-way street" attribute 87b as indicated by a solid arrow is assigned to the road 82, and a "two-way street" attribute 87c as indicated by a solid arrow is assigned to the entrance or exit road 83. "Intersection" attributes 88a to 88k as indicated by black circles are assigned to intersecting positions between traveling routes.

The "one-way street" attributes 86a to 86i, "two-way street" attributes 87a to 87c, and "intersection" attributes 88a to 88k, along with recognized position coordinates thereof, are transmitted from the information terminal 200 to the vehicle 1 and stored in the storage unit 37 of the control device 30 of the vehicle 1. When the vehicle 1 travels in the parking lot 81, the vehicle 1 performs automatic traveling based on a route in the parking lot 81 recognized based on the external environment information and attribute information associated with position coordinates of the route and assigned to the map information 71.

### 6. Use Form of Automatic Traveling

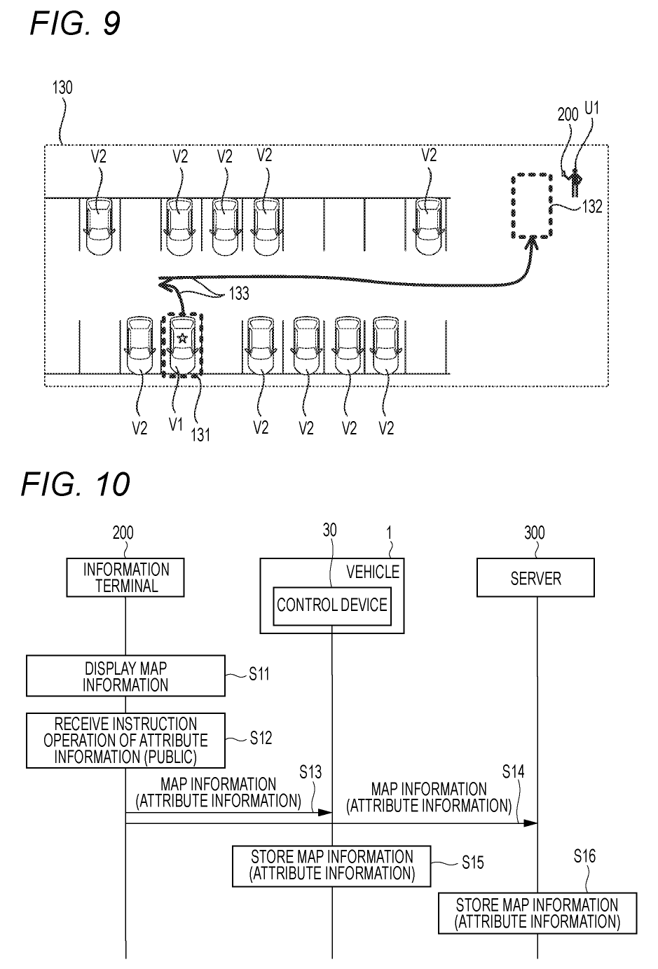

FIG. 9 is a diagram illustrating an example of a use form of the present embodiment when calling a vehicle. As illustrated in FIG. 9, the user U1 intends to use the information terminal 200 to cause a host vehicle V1, which is parked at a parking position 131 in a parking lot 130, to perform automatic exiting to a calling position 132 where the user U1 is. The parking lot 130 is assumed to be, for example, a parking lot at a shopping mall. In addition to the host vehicle V1, a plurality of other vehicles V2 are parked in the parking lot 130.

When the vehicle V1 travels in the parking lot 130 and performs automatic exiting from the parking position 131 to the calling position 132 where the user U1 is, the host vehicle V1 performs automatic traveling along, for example, an exit route 133 based on a route in the parking lot 130 recognized based on the external environment information acquired by the external environment sensor 11 and the attribute information associated with position coordinates of the route and assigned to map information of the parking lot 130. Note that a use form of the automatic traveling based on the attribute information may include, in addition to the automatic exiting of calling a vehicle, automatic parking of parking a vehicle in a predetermined parking position, or memory traveling with a user in the vehicle.

### 7. Acquisition of Map Information

FIG. 10 is a diagram illustrating a first example of a sequence for acquiring the map information to which the attribute information has been assigned. Note that in the present example, a case will be described in which a user performs an instruction operation on the map information via the information terminal 200 owned by the user.

First, the information terminal 200 displays the map information on the touch panel 241 (step S11). The map information is, for example, map information including an area of a parking lot where the user intends to cause the vehicle 1 to perform automatic traveling (automatic parking/automatic exiting). The information terminal 200 receives an instruction operation from the user to assign the attribute information to the map information (step S12). The parking lot where the vehicle 1 is caused to perform automatic traveling here is, for example, a public parking lot of a shopping mall or the like. Therefore, the attribute information assigned to the map information is public attribute information. The information terminal 200 transmits the map information to which the attribute information has been assigned by the instruction operation from the user to the control device 30 of the vehicle 1 (step S13). Similarly, the information terminal 200 transmits the map information to which the attribute information has been assigned to the server 300 (step S14).

The control device 30 stores the map information with the attribute information received (acquired) from the information terminal 200 in the storage unit 37 (step S15).

The server 300 stores the map information with the attribute information received from the information terminal 200 (step S16).

In the first example, the control device 30 acquires the map information to which the attribute information has been assigned from the information terminal 200.

Note that in the above example, the public attribute information has been assigned to the map information, but if private attribute information is assigned to the map information, the map information with the private attribute is transmitted from the information terminal 200 to the control device 30, but is not transmitted from the information terminal 200 to the server 300.

There may be a configuration in which the map information to which the attribute information has been assigned is registered in the server 300, and only the vehicle 1 (control device 30) of the user belonging to a specific group or the information terminal 200 of the user belonging to a specific group can receive the registered map information. The "specific group" may be a group to which an uploaded user belongs, or may be a user who is permitted to download according to a contract with a service provider (such as subscribing to a premium plan).

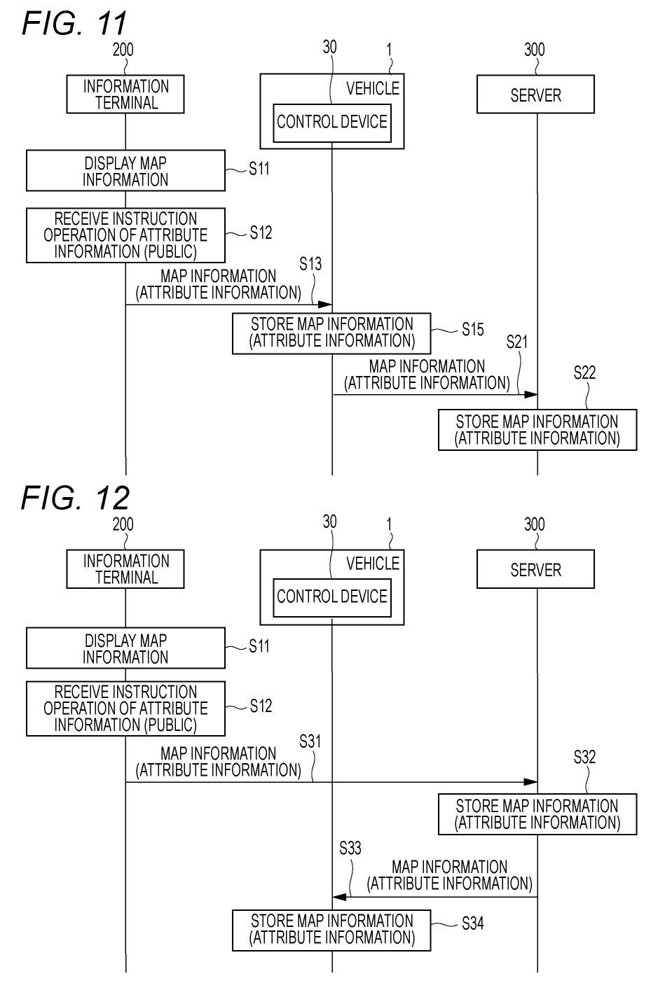

FIG. 11 is a diagram illustrating a second example of the sequence for acquiring the map information to which the attribute information has been assigned. As illustrated in FIG. 11, processing from step S11 to step S13 and processing of step S15 are the same as the processing from step S11 to step S13 and the processing of step S15 in FIG. 10.

The control device 30, which has stored the map information to which the attribute information has been assigned in step S15, transmits the map information to which the attribute information has been assigned to the server 300 (step S21). In the first example of FIG. 10 described above, the information terminal 200 transmits the map information to which the attribute information has been assigned to the server 300, but in the second example, the control device 30 transmits the map information to the server 300.

The server 300 stores the map information with the attribute information received from the control device 30 (step S22).

In the second example, the control device 30 acquires the map information to which the attribute information has been assigned from the information terminal 200.

FIG. 12 is a diagram illustrating a third example of the sequence for acquiring the map information to which the attribute information has been assigned. As illustrated in FIG. 12, processing from step S11 to step S12 are the same as the processing from step S11 to step S12 in FIG. 10.

The information terminal 200 receives an instruction operation from the user and transmits the map information to which the attribute information has been assigned to the server 300 (step S31).

The server 300 stores the map information with the attribute information received from the information terminal 200 (step S32). The server 300 transmits the map information to which the attribute information has been assigned to the control device 30 of the vehicle 1 (step S33).

The control device 30 stores the map information with the attribute information received (acquired) from the server 300 in the storage unit 37 (step S34).

In the third example, the control device 30 acquires the map information to which the attribute information has been assigned from the server 300.

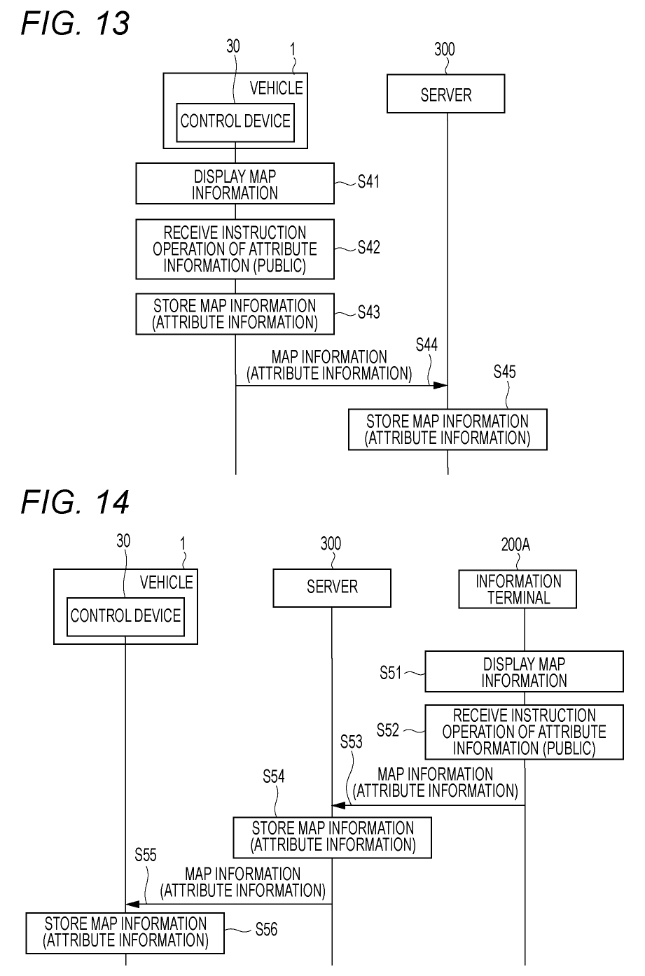

FIG. 13 is a diagram illustrating a fourth example of the sequence for acquiring the map information to which the attribute information has been assigned. Note that in the present example, a case will be described in which the user performs an instruction operation on the map information via the navigation device 20 installed in the vehicle 1.

First, the control device 30 of the vehicle 1 displays the map information on the touch panel 22 of the navigation device 20 (step S41). The control device 30 receives an instruction operation from the user to assign the attribute information to the map information (step S42). The attribute information assigned to the map information is public attribute information. The control device 30 receives the instruction operation from the user and stores the map information to which the attribute information has been assigned in the storage unit 37 (step S43). The control device 30 transmits the map information to which the attribute information has been assigned to the server 300 (step S44).

The server 300 stores the map information with the attribute information received from the control device 30 (step S45).

In the fourth example, the control device 30 receives the instruction operation from the user on the touch panel 22 of the navigation device 20, thereby acquiring the map information to which the attribute information has been assigned.

FIG. 14 is a diagram illustrating a fifth example of the sequence for acquiring the map information to which the attribute information has been assigned. Note that in the present example, a case will be described in which attribute information from an information terminal 200A of another user is assigned to the map information.

The information terminal 200A displays the map information on the touch panel of the information terminal 200A (step S51). The information terminal 200A receives an instruction operation from the user to assign the attribute information to the map information (step S52). The attribute information assigned to the map information is public attribute information. The information terminal 200A receives an instruction operation from the user and transmits the map information to which the attribute information has been assigned to the server 300 (step S53).

The server 300 stores the map information with the attribute information received from the information terminal 200A (step S54). The server 300 transmits the map information to which the attribute information has been assigned to the control device 30 of the vehicle 1 (step S55).

The control device 30 stores the map information with the attribute information received (acquired) from the server 300 in the storage unit 37 (step S56).

The control device 30 of the fifth example acquires from the server 300 the map information with the attribute information transmitted from another user (information terminal 200A) to the server 300. Note that in the present example, the server 300 transmits the map information to which the attribute information has been assigned to the control device 30, but the present invention is not limited thereto. For example, the information terminal 200 may download the map information with the attribute information from the server 300, and the information terminal 200 may transmit the downloaded map information with the attribute information to the control device 30.

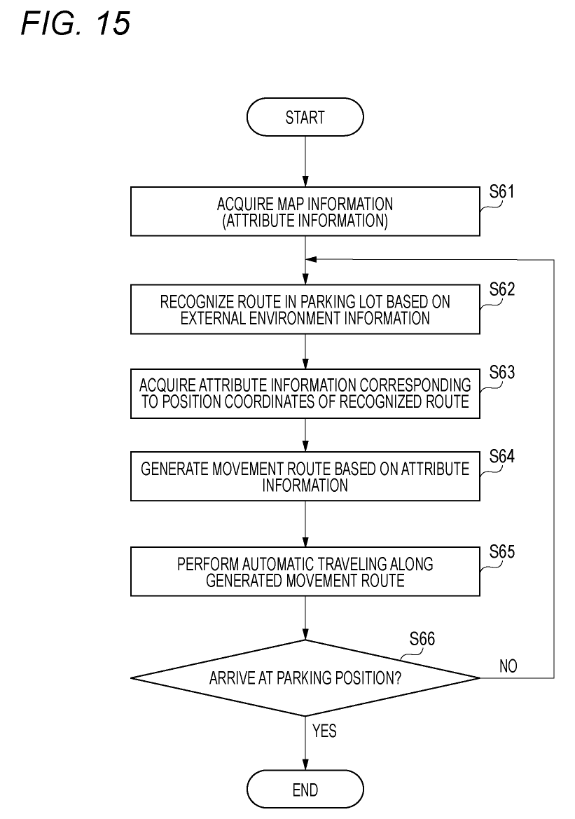

FIG. 15 is a flowchart illustrating an example of processing by the control device 30 during automatic traveling of the vehicle 1. The processing of the present example is started when the automatic traveling in the parking lot begins. For example, in the case of automatic exiting from the parking position to a getting-in position, the processing of the present example is started when the vehicle 1 is called by, for example, the information terminal 200. In the case of automatic parking from a getting-out position where the user gets out of the vehicle 1 to the parking position, the processing in the present example is started when the user gets out and the automatic driving begins. In the case of memory parking based on an automatic traveling route memorized in the control device 30, the processing of the present example is started when the memory parking begins (when arriving at the parking lot). Note that in the present example, a case will be described in which the vehicle 1 performs automatic parking at a predetermined parking position. It is also assumed that the map information to which the attribute information has been assigned of the parking lot has already been stored in the storage unit 37 of the control device 30.

First, the control device 30 acquires the map information to which the attribute information has been assigned from the storage unit 37 (step S61).

Next, the control device 30 recognizes a route in the parking lot based on the external environment information acquired by the external environment sensor 11 (step S62).

The control device 30 acquires the attribute information assigned to the map information corresponding to position coordinates of the route recognized in step S62 (step S63).

The control device 30 generates a movement route for the vehicle 1 based on the attribute information acquired in step S63 (step S64). The movement route for the vehicle 1 is a route for automatic parking from the getting-out position where the user gets out of the vehicle 1 to a predetermined parking position where the vehicle 1 is parked.

The control device 30 causes the vehicle 1 to perform automatic traveling along the movement route generated in step S64 (step S65).

Next, the control device 30 determines whether the vehicle 1 has arrived at the parking position (step S66). If the vehicle 1 has not arrived at the parking position (step S66: No), the control device 30 returns to step S62 and executes each processing. If the vehicle 1 has arrived at the parking position (step S66: Yes), the control device 30 ends this processing.

Incidentally, in order to cause the vehicle to perform automatic traveling in the parking lot, information such as an environment in the parking lot, a registered route, and a parking section is required. Examples of a method for causing the vehicle to perform automatic traveling include, for example, a method of memorizing the environment in the parking lot, the route, the parking section, and the like in advance and using the memorized information for the traveling, and a method of using route information registered by the map maker or the like. However, the method of using the memorized information requires the user to manually drive the vehicle in the parking lot in advance to memorize information such as the traveling route and the like, which requires a lot of preparation work. In the method of using map registered by the map maker, information on public roads can be used since the information has been registered, but information on parking lots of a private land or the like is often not available since registration and maintenance has not progressed.

In contrast, the control device 30 of the present embodiment controls the automatic traveling of the vehicle 1 based on the external environment information of the vehicle 1 acquired by the external environment sensor 11 and attribute information on the route in the parking lot that is assigned to the map information based on the instruction operation from the user on the map information of the parking lot. According to this configuration, the attribute information on the route in the parking lot can be assigned based on the instruction operation from the user on the map information, so that the attribute information on, for example, traveling restrictions set in the parking lot can be easily and accurately assigned to the map information. Therefore, even in a parking lot that is not registered and maintained on the map of the map maker, attribute information can be assigned by the instruction operation from the user. In this way, the automatic traveling can be appropriately performed based on the assigned attribute information, thereby improving convenience of automatic traveling. For example, in a case where the one-way street information is displayed in the parking lot, but the display is fading and it is difficult to determine using image recognition based on the external environment information, the one-way street information can be accurately determined based on the attribute information assigned to the map information.

The control device 30 can assign the attribute information to the map information by an instruction operation on the touch panel 22 of the navigation device 20 or an instruction operation on the information terminal 200 by the user. In this way, even when the user is at a position far away from the parking lot where the vehicle 1 performs automatic traveling, the attribute information on the route in the parking lot can be assigned to the map information from the distant position. Therefore, it is possible to easily and accurately prepare the map information to which the attribute information has been assigned in advance before going to the parking lot.

The control device 30 controls the automatic traveling of the vehicle 1 based on the route in the parking lot recognized based on the external environment information and the attribute information associated with the position information of the route. With this configuration, it is possible to easily associate the route in the parking lot with the attribute information assigned to the map information of the parking lot based on, for example, position information from GPS signals, thereby further improving the convenience of automatic traveling.

The control device 30 detects the attribute information that is not associated with a location in the map information based on the external environment information, and if the location is not associated with another attribute information of the same or different type as the detected attribute information, the control device 30 associates the detected attribute information with the location and assigns the detected attribute information to the map information. If another different attribute information is associated with the location, a conflict determination is performed between the two pieces of attribute information, and if the two pieces of attribute information do not conflict with each other, the detected attribute information is associated with the location, and added and assigned to the map information. If the location is associated with another different attribute information and the two pieces of attribute information conflict with each other, the user is inquired about whether to update to the detected attribute information, and if an update operation is received from the user, the detected attribute information is associated with the location and used for overwriting the map information. According to this configuration, even when the attribute information assigned to the map information by the instruction operation from the user is not set to the latest state, the attribute information is updated to the newly detected attribute information during the automatic traveling in the parking lot, thereby further improving the convenience of automatic traveling.

Furthermore, the control device 30 transmits the map information to which the attribute information has been assigned to the server 300 based on the transmission permission information that can be assigned by a user operation. According to this configuration, many users can freely use the map information with the attribute information transmitted to the server 300, thereby improving the convenience of automatic traveling. By continuously expanding the map information with the attribute information that anyone can use, it will become unnecessary for each user to generate map information via the information terminal or the navigation device, thereby improving the convenience of automatic traveling.

Although various embodiments have been described above with reference to the drawings, it is needless to say that the present invention is not limited to these examples. It is apparent to those skilled in the art that various changes or modifications can be conceived within the scope described in the claims, and it is understood that the changes or modifications naturally fall within the technical scope of the present invention. In addition, the constituent elements in the above embodiment may be freely combined without departing from the gist of the invention.

The control method described in the above embodiment may be implemented by executing a program (control program) prepared in advance on a computer. For example, the present program is stored in a computer-readable storage medium and executed by being read from the storage medium. The present program may be provided in a form of being stored in a nonvolatile (non-transitory) storage medium such as a flash memory, or may be provided via a network such as the Internet.

In the embodiment described above, the computer that executes the program is the control device 30 provided in the vehicle 1, but the present invention is not limited thereto. For example, the computer that executes the present program may be provided in another device (for example, the external device 2) capable of communicating with the control device 30.

In the present specification, at least the following matters are described. In the parentheses, the corresponding constituent elements and the like in the above embodiment are shown as examples, but the present invention is not limited thereto.

(1) A control device (control unit 31) for a moving object (vehicle 1) capable of autonomous traveling to a target position, the control device including:

a processor (control device 30) configured to

acquire external environment information of the moving object,

acquire attribute information on a route in a parking lot, the attribute information assigned to map information based on an instruction operation performed by a user on displayed map information of the parking lot, and

control the autonomous traveling based on the external environment information and the attribute information assigned to the map information.

According to (1), the attribute information on the route in the parking lot can be assigned to the map information based on the instruction operation from the user on the map information of the parking lot, so that the set attribute information in the parking lot can be easily and accurately assigned to the map information. In this way, appropriate autonomous traveling in the parking lot using the assigned attribute information is enabled. Therefore, the convenience of autonomous traveling is improved.

(2) The control device according to (1), further including

a display (touch panel 22) configured to display the map information and receive the instruction operation on the displayed map information, in which

the processor assigns the attribute information to the map information according to the instruction operation received by the display.

According to (2), the attribute information can be assigned to the map information by performing the instruction operation on the display, so that the attribute information is easily assigned by the user.

(3) The control device according to (1) or (2), further including

a communication interface (communication interface 70) capable of communicating with an information terminal (information terminal 200) that displays the map information and assigns the attribute information to the map information by the instruction operation on the displayed map information, in which

the processor acquires the attribute information assigned to the map information from the information terminal via the communication interface.

According to (3), it is possible to perform the instruction operation to assign the attribute information to the map information by the information terminal, and the attribute information assigned to the map information can be acquired from the information terminal via communication, and therefore, the attribute information is easily assigned.

(4) The control device according to any of (1) to (3), in which

the attribute information includes information on a traveling restriction in the parking lot.

As in (4), it is preferable that the attribute information associated with the autonomous traveling includes the information on the traveling restriction in the parking lot.

(5) The control device according to any of (1) to (4), in which

the map information indicates an area corresponding to the parking lot,

the attribute information is assigned to the map information in association with a position coordinate in the parking lot, and

the processor controls the autonomous traveling based on a route in the parking lot recognized based on the external environment information and the attribute information associated with the position coordinate of the route.

According to (5), by associating the route in the parking lot recognized based on the external environment information with the attribute information assigned to the map information of the parking lot based on position information, more appropriate autonomous traveling in the parking lot becomes possible.

(6) The control device according to any of (1) to (5), in which

when a plurality of route candidates for the autonomous traveling includes a route candidate to which the attribute information is assigned in the map information, the processor sets the route candidate to which the attribute information is assigned as a movement route for the autonomous traveling.

As in (6), it is preferable to preferentially set a route to which the attribute information is assigned in the map information as the movement route for the autonomous traveling.

(7) The control device according to any of (1) to (6), in which

the processor sets only a route to which the attribute information is assigned in the map information as a movement route for the autonomous traveling.

As in (7), it is more preferable to set only a route to which the attribute information is assigned in the map information as the movement route for the autonomous traveling.

(8) The control device according to any of (1) to (7), in which

the processor

detects first attribute information based on the external environment information, the first attribute information being information on a route at a first location in the parking lot that is not associated with the first location in the map information, and

assigns the first attribute information to the map information in association with the first location when the first location is not associated with second attribute information that is different from the first attribute information in the map information.

According to (8), the attribute information that is not associated with a location in the map information is detected based on the external environment information, and if the location is not associated with another attribute information of the same or different type, the detected attribute information is associated with the location and therefore the attribute information of the parking lot can be further accurately assigned to the map information.

(9) The control device according to (8), in which

the processor

performs a conflict determination between the first attribute information and the second attribute information when the first attribute information is detected and the second attribute information is associated with the first location in the map information, and

assigns the first attribute information to the map information in association with the first location when the first attribute information and the second attribute information are determined not to conflict with each other.

According to (9), the attribute information that is not associated with a location in the map information is detected based on the external environment information, and if another different attribute information is associated with the location, a conflict determination is made between the two pieces of attribute information, and if the two pieces of attribute information do not conflict with each other, the detected attribute information is associated with the location and added and assigned to the map information, so that the attribute information of the parking lot can be assigned to the map information more accurately.

(10) The control device according to (9), in which

the processor

performs an inquiry to the user as to whether to update from the second attribute information to the first attribute information when the first attribute information and the second attribute information are determined to conflict with each other, and

assigns the first attribute information, instead of the second attribute information, to the map information in association with the first location when an update operation performed by the user is received in response to the inquiry.

According to (10), the attribute information that is not associated with a location in the map information is detected based on the external environment information, and if another different attribute information is associated with the location and the two pieces of attribute information conflict with each other, the user is inquired of as to whether to update to the detected attribute information, and if an update operation is received from the user, the detected attribute information is associated with the location and the attribute information in the map information is overwritten, so that the attribute information of the parking lot can be assigned to the map information more accurately.

(11) The control device according to any of (1) to (10), further including

a communication interface capable of communicating with a server, in which

the processor (attribute information transmission unit 32) is configured to transmit the map information to which the attribute information is assigned to the server via the communication interface, and in which

transmission permission information can be assigned to the attribute information by a user operation, the transmission permission information indicating whether transmission to the server is permitted, and

the processor transmits the map information to which the attribute information is assigned to the server based on the transmission permission information.

According to (11), the map information to which the attribute information is assigned can be transmitted to the server based on the transmission permission information that can be assigned by a user operation, so that many users can use the map information with the attribute information transmitted to the server, and highly convenient autonomous traveling is possible.

(12) A control method for a control device for a moving object capable of autonomous traveling to a target position, the control method including:

acquiring, by a processor, external environment information of the moving object;

acquiring, by the processor, attribute information on a route in a parking lot, the attribute information assigned to map information based on an instruction operation performed by a user on displayed map information of the parking lot; and

performing, by the processor, a control of the autonomous traveling based on the external environment information and the attribute information assigned to the map information.

According to (12), the attribute information on the route in the parking lot can be assigned to the map information based on the instruction operation from the user on the map information of the parking lot, so that the set attribute information in the parking lot can be easily and accurately assigned to the map information. In this way, appropriate autonomous traveling in the parking lot using the assigned attribute information is enabled. Therefore, the convenience of autonomous traveling is improved.

(13) A non-transitory computer-readable storage medium storing a control program for a computer to perform processing, the computer configured to control a control device of a moving object capable of autonomous traveling to a target position, the processing including:

acquiring external environment information of the moving object;

acquiring attribute information on a route in a parking lot, the attribute information assigned to map information based on an instruction operation performed by a user on displayed map information of the parking lot; and

performing a control of the autonomous traveling based on the external environment information and the attribute information assigned to the map information.

According to (13), the attribute information on the route in the parking lot can be assigned to the map information based on the instruction operation from the user on the map information of the parking lot, so that the set attribute information in the parking lot can be easily and accurately assigned to the map information. In this way, appropriate autonomous traveling in the parking lot using the assigned attribute information is enabled. Therefore, the convenience of autonomous traveling is improved.

(14) An information terminal including:

a communication interface (communication interface 230) capable of communicating with a control device for a moving object capable of autonomous traveling to a target position;

a user interface (user interface 240) configured to display map information of a parking lot; and

a processor (processor 210), in which

the processor is configured to

assign attribute information on a route in the parking lot to the map information based on an instruction operation performed by a user on the map information displayed on the user interface, and

cause, by transmitting the map information to which the attribute information is assigned to the control device via the communication interface, the control device to execute a control of the autonomous traveling based on external environment information of the moving object and the attribute information assigned to the map information.

According to (14), the attribute information on the route in the parking lot can be assigned to the map information based on the instruction operation from the user on the map information of the parking lot, and the map information to which the attribute information is assigned can be transmitted to the control device for the moving object, so that the set attribute information in the parking lot can be easily and accurately assigned to the map information. In this way, the moving object can be caused to perform appropriate autonomous traveling in the parking lot based on the assigned attribute information. Therefore, the convenience of autonomous traveling of the moving object can be improved.

(15) A control method for an information terminal including a communication interface that can communicate with a control device for a moving object capable of autonomous traveling to a target position, a user interface that displays map information of a parking lot, and a processor, the control method including:

assigning attribute information on a route in the parking lot to the map information based on an instruction operation performed by a user on the map information displayed on the user interface; and

causing, by transmitting the map information to which the attribute information is assigned to the control device via the communication interface, the control device to control the autonomous traveling based on external environment information of the moving object and the attribute information assigned to the map information.

According to (15), the attribute information on the route in the parking lot can be assigned to the map information based on the instruction operation from the user on the map information of the parking lot, and the map information to which the attribute information is assigned can be transmitted to the control device for the moving object, so that the set attribute information in the parking lot can be easily and accurately assigned to the map information. In this way, the moving object can be caused to perform appropriate autonomous traveling in the parking lot based on the assigned attribute information. Therefore, the convenience of autonomous traveling of the moving object can be improved.

(16) A non-transitory computer-readable storage medium storing a control program for a computer to perform processing, the computer configured to control an information terminal including a communication interface that can communicate with a control device for a moving object capable of autonomous traveling to a target position, a user interface that displays map information of a parking lot, and a processor, the processing including:

assigning attribute information on a route in the parking lot to the map information based on an instruction operation performed by a user on the map information displayed on the user interface; and

causing, by transmitting the map information to which the attribute information is assigned to the control device via the communication interface, the control device to control the autonomous traveling based on external environment information of the moving object and the attribute information assigned to the map information.

According to (16), the attribute information on the route in the parking lot can be assigned to the map information based on the instruction operation from the user on the map information of the parking lot, and the map information to which the attribute information is assigned can be transmitted to the control device for the moving object, so that the set attribute information in the parking lot can be easily and accurately assigned to the map information. In this way, the moving object can be caused to perform appropriate autonomous traveling in the parking lot based on the assigned attribute information. Therefore, the convenience of autonomous traveling of the moving object can be improved.

What is claimed is:

1. A control device for a moving object capable of autonomous traveling to a target position, the control device comprising:
a processor configured to
acquire external environment information of the moving object,
acquire attribute information on a route in a parking lot, the attribute information assigned to map information based on an instruction operation performed by a user on displayed map information of the parking lot, and
control the autonomous traveling based on the external environment information and the attribute information assigned to the map information.

2. The control device according to claim 1, further comprising
a display configured to display the map information and receive the instruction operation on the displayed map information, wherein
the processor assigns the attribute information to the map information according to the instruction operation received by the display.

3. The control device according to claim 1, further comprising
a communication interface capable of communicating with an information terminal that displays the map information and assigns the attribute information to the map information by the instruction operation on the displayed map information, wherein
the processor acquires the attribute information assigned to the map information from the information terminal via the communication interface.

4. The control device according to claim 1, wherein
the attribute information includes information on a traveling restriction in the parking lot.

5. The control device according to claim 1, wherein
the map information indicates an area corresponding to the parking lot,
the attribute information is assigned to the map information in association with a position coordinate in the parking lot, and
the processor controls the autonomous traveling based on a route in the parking lot recognized based on the external environment information and the attribute information associated with the position coordinate of the route.

6. The control device according to claim 1, wherein
when a plurality of route candidates for the autonomous traveling includes a route candidate to which the attribute information is assigned in the map information, the processor sets the route candidate to which the attribute information is assigned as a movement route for the autonomous traveling.

7. The control device according to claim 1, wherein
the processor sets only a route to which the attribute information is assigned in the map information as a movement route for the autonomous traveling.

8. The control device according to claim 1, wherein
the processor
detects first attribute information based on the external environment information, the first attribute information being information on a route at a first location in the parking lot that is not associated with the first location in the map information, and
assigns the first attribute information to the map information in association with the first location when the first location is not associated with second attribute information that is different from the first attribute information in the map information.

9. The control device according to claim 8, wherein
the processor
performs a conflict determination between the first attribute information and the second attribute information when the first attribute information is detected and the second attribute information is associated with the first location in the map information, and
assigns the first attribute information to the map information in association with the first location when the first attribute information and the second attribute information are determined not to conflict with each other.

10. The control device according to claim 9, wherein
the processor
performs an inquiry to the user as to whether to update from the second attribute information to the first attribute information when the first attribute information and the second attribute information are determined to conflict with each other, and
assigns the first attribute information, instead of the second attribute information, to the map information in association with the first location when an update operation performed by the user is received in response to the inquiry.

11. The control device according to claim 1, further comprising
a communication interface capable of communicating with a server, wherein
the processor is configured to transmit the map information to which the attribute information is assigned to the server via the communication interface, and wherein
transmission permission information can be assigned to the attribute information by a user operation, the transmission permission information indicating whether transmission to the server is permitted, and
the processor transmits the map information to which the attribute information is assigned to the server based on the transmission permission information.

12. A control method for a control device for a moving object capable of autonomous traveling to a target position, the control method comprising:
acquiring, by a processor, external environment information of the moving object;
acquiring, by the processor, attribute information on a route in a parking lot, the attribute information assigned to map information based on an instruction operation performed by a user on displayed map information of the parking lot; and
performing, by the processor, a control of the autonomous traveling based on the external environment information and the attribute information assigned to the map information.

13. A non-transitory computer-readable storage medium storing a control program for a computer to perform processing, the computer configured to control a control device of a moving object capable of autonomous traveling to a target position, the processing comprising:
acquiring external environment information of the moving object;
acquiring attribute information on a route in a parking lot, the attribute information assigned to map information based on an instruction operation performed by a user on displayed map information of the parking lot; and
performing a control of the autonomous traveling based on the external environment information and the attribute information assigned to the map information.

14. An information terminal comprising:
a communication interface capable of communicating with a control device for a moving object capable of autonomous traveling to a target position;
a user interface configured to display map information of a parking lot; and
a processor, wherein
the processor is configured to
assign attribute information on a route in the parking lot to the map information based on an instruction operation performed by a user on the map information displayed on the user interface, and
cause, by transmitting the map information to which the attribute information is assigned to the control device via the communication interface, the control device to execute a control of the autonomous traveling based on external environment information of the moving object and the attribute information assigned to the map information.
